(19) United States
(12) Patent Application Publication
(10) Pub. No.: US 2003/0043109 A1
(43) Pub. Date: Mar. 6, 2003

(54) Portable personal computer system

(76) Inventor: Cuc Hong, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 09/941,267

(22) Filed: Aug. 29, 2001

(51) Int. Cl. G09G 5/00; G09G 5/08

(52) U.S. Cl. 345/156; 345/166

(57) ABSTRACT

A single unit compact, self-contained, portable personal computer system includes an enclosure having a power supply port disposed on outside of the enclosure, a computer system configured and arranged in the enclosure, and a handle and at least one wheel to transport the system by pulling the handle, wherein the handle is extendable from the enclosure and retractable into the enclosure. The computer system includes a plurality of personal computer components having an input device and an output device, a printing module, a scanning module, a copying module, a laptop docking, and a video cam, etc. In one embodiment, a CPU, memory, a motherboard, a hard drive, an operating system, user interface components including an infrared mouse, an infrared keyboard, and a flat screen display, and components including a scanning device, a printing unit, and a complete PC telephony system, etc., all possessing a single power supply are contained within a single system enclosure. The portable personal computer system combines the functionality of a traditional desktop system with the efficiency of a traditional laptop system, allowing a user portable, multi-functional capability while minimizing the desk space and set-up time required for operation.

### FIELD OF THE INVENTION

The present invention relates to a personal computer system having capabilities such as computing, printing, scanning, copying, laptop docking, audio/video, etc. More particularly, the present invention relates to a compact, self-contained portable personal computer system configured and arranged in a single unit capable of computing, printing, scanning, copying, laptop docking, audio/video, etc.

### BACKGROUND

Traditionally, computer users must choose between alternative computing systems for their computing needs. The user's choice of systems largely depends on the desired application. Workstations associated with a centralized server system, main frame or super computer still exists. The home or student user often purchases a traditional desktop personal computer to be kept in a den, home office, computer room or dorm room. The traditional desktop computer system contains multiple primary components such as a central processing unit, memory (e.g. Random-Access Memory, Read-Only Memory, Cache), a motherboard, a hard drive, an operating system, and sound and graphics cards. Other user-interface devices, such as the monitor, mouse and keyboard, allow a user to interact with the primary devices and are connected by separate wires of varying lengths and sizes through conventional interfaces to these primary devices. In addition to these components, a desktop computer is often connected to or networked with various peripheral devices such as a video cam, a voice system, a document scanner and printer, each of which are also hard wired by separate wires of varying lengths and sizes through conventional interfaces to the primary devices. This combination of components is highly functional and allows the user a wide range of capabilities.

The traditional desktop computer possesses numerous advantages, including but not limited to, its ability to process vast amounts of data without error, to enable its user to produce documents efficiently, and to allow the user maximum editorial control over the production of those documents. The desktop computer can automate certain ordinary tasks from turning on outside lights in the evening to brewing coffee in the morning. As a multimedia tool, the desktop computer also gives its user the ability to produce information in a graphical audio and video format, allowing studio-like presentations. Certain disadvantages, however, are inherent in the desktop computer's configuration.

Due to its bulk and weight, a desktop computer system and its multiple peripheral devices are difficult to transport. Consequently, moving the system is often only feasible when permanently relocating the system to another area and it must be disassembled and reassembled to accomplish the move. Each of the multiple peripheral and user-interface components also requires its own power supply, increasing the number of power cords, external AC adaptors, and multi-pronged electrical plugs needed for operation. The multiple peripheral components and power supplies also require a large amount of desk space for operation, and increase the complexity of and the time required for the desktop's set-up and configuration procedure. These limitations lessen the feasibility of utilizing such a system in small businesses, college dormitories, and homes.

The present invention also utilizes and improves upon certain features of the laptop computer system. Unlike the typical home or dorm room user, a business traveler often purchases a laptop computer. A laptop computer is a portable personal computer that avoids many of the desktop computer's disadvantages. Because of its size, a laptop computer is easy to transport. Its internal configuration of components such as the keyboard, cursor control sensor, and monitor allows for minimal set-up and configuration time and requires less desk space for operation. At typically less than 10 lbs., a laptop computer also weighs less than a desktop computer. However, a laptop computer lacks the functionality and comfort of a traditional desktop computer.

A laptop computer's screen usually presents substantially less viewing area than a desktop computer's monitor. Similarly, a laptop computer's keyboard is usually smaller than a standard keyboard, and a laptop computer's trackball or touch pad may be more difficult to use than a standard mouse. A laptop computer generally has less storage space on its internal disk drive than a traditional desktop. Also, a laptop computer often allows its user to access only one type of disk drive at a time. To compensate for this lack of functionality and comfort, a laptop computer can support added peripheral devices such as a full sized keyboard and mouse, one or more speakers, and a variety of external storage devices, all hard wired to interfaces and/or to each other. The addition of these devices however creates transportation and weight limitations similar to those of a desktop computer.

Accordingly, improvements on the existing personal computers are desired. For example, it would be advantageous to provide a combination of primary computer devices and peripheral computer devices within a single system enclosure, wherein the enclosure is easily transported and requires minimal desk space and set-up time for operation.

### SUMMARY

To resolve the above and other problems and disadvantages of the existing personal computer systems, the present invention provides a combination of the functionality and capability of a desktop computer and its various peripheral devices, including a document scanner and printer, with the convenience and portability of a laptop computer thereby reducing the system's weight and the desk space required for operation, and simplifying the system's set-up procedures.

In one embodiment of the present invention, multiple primary and peripheral devices, including a central processing unit, at least one memory device, a motherboard, a hard drive, sound and graphics cards, a video cam, a microphone, one or more speakers, a document scanning device and a printing unit, etc., are configured and arranged in a single system enclosure equipped with a handle and at least one transport wheel.

A traditional system equipped with various external devices often requires a complicated set-up procedure. Typically, a traditional system will come packaged with various instructions and hints for performing the often time-consuming procedure. One advantage of the present invention is that it allows a consumer to purchase a preconfigured system, requiring no time-consuming and complicated set-up procedures. In one embodiment of the present invention, an operating system may be pre-installed, and the requisite software and drivers required for operating the included devices may be embedded as well. Also, the present invention minimizes the number of documents normally included in the purchase of a personal computer that describe the system's setup procedures and operation.

Typically, the need to connect various peripheral and user-interface devices to a personal computer clutters the desk and floor space around such a system. A printer, a scanner, one or more speakers, a video cam, and a monitor, all connected to a standard personal computer, would each need a cable connecting the particular device to the personal computer and a power cord connecting the particular device to a power source. In most instances, this configuration leads to a tangle of wires connected to a power strip, causing an unsightly and unsafe working area that impedes a user's ability to quickly identify the location of a particular device's interface with the computer and may result in damage to the connecting cords and cables. One advantage of the present invention is that it eliminates these concerns by combining the separate power supplies for each of the various devices into a single power supply serving all functions of the present invention. In one embodiment of the present invention, a single electrical prong disposed outside of a system enclosure and a single power cord connected to the electrical prong are the only pieces of the system's power supply visible to a user. A user can power the entire system by simply plugging the power cord into a power outlet and turning the power on the system enclosure.

Another advantage of the present invention is that it eliminates the bulky monitor traditionally associated with a desktop computer system and includes a flat screen display that is connected to the system's power supply. In one embodiment of the present invention, a flat screen display is hinged to a system enclosure so that in a closed position the flat screen display folds into the system enclosure, and in an open position the flat screen display remains upright at a height sufficient to minimize the strain on a user's neck.

In further minimizing the number of external devices and corresponding connection cords or cables, one embodiment of the present invention includes an infrared mouse and an infrared keyboard. An infrared sensor within the computer system provides an optical interface between the system and the mouse and between the system and the keyboard. The infrared keyboard can be stored completely within the system enclosure in a keyboard storage tray. By storing the infrared keyboard within the keyboard storage tray when not in use, the user can completely remove the infrared keyboard from view thereby further reducing the clutter surrounding the system and maintaining an aesthetically pleasing work area. Further in one embodiment, a docking station is built in the keyboard storage tray for docking with another computer system.

Because of its various components contained in a single system enclosure, the present invention provides an easy-to-use, multi-functional system within a portable housing. Further, the overall weight of the system is considerably reduced. These features and other aspects and advantages of the present invention will become clear after examining the following description, appended claims, and accompanying drawings.

### BRIEF DESCRIPTION OF THE DRAWINGS

The novel features of the present invention are set forth in the appended claims. The invention itself will be best understood by reference to the following detailed description when considered in conjunction with the accompanying drawings, wherein:

FIG. 1 is a front perspective view of one embodiment of a portable personal computer system, in accordance with the principles of the present invention, having a flat screen display raised to an open position, a video cam integral to the flat screen display, and a front panel opened to illustrate an infrared keyboard and an infrared mouse stored in a tray, and a docking station built in the tray.

FIG. 2 is a bottom perspective view of one embodiment of a portable personal computer system, in accordance with the principles of the present invention, showing an extended handle capable of pulling the computer system and a top handle for carrying/lifting the computer system.

FIG. 3 is a rear perspective view of one embodiment of a portable personal computer system, in accordance with the principles of the present invention, showing a side panel in an open position to illustrate media ports, and showing cooling facilities and interconnects on the back of the computer system.

FIG. 4 is a perspective view of one embodiment of a portable personal computer, in accordance with the principles of the present invention, being transported by a pulling handle extended out of a system enclosure.

FIG. 5 is a perspective view of one embodiment of a portable personal computer system, in accordance with the principles of the present invention, housed in a carrying case with a pulling handle extended out of the carrying case.

FIG. 6 is a perspective view of one embodiment of a portable personal computer system, in accordance with the principles of the present invention, showing bottom of the carrying case with wheels for transport and stops for stand.

### DETAILED DESCRIPTION OF THE PREFERRED EMBODIMENTS

The present invention relates to a personal computer system having capabilities such as computing, printing, scanning, copying, laptop docking, audio/video, etc. More particularly, the present invention relates to a compact, self-contained portable personal computer system configured and arranged in a single unit capable of computing, printing, scanning, copying, laptop docking, audio/video, etc.

The present invention allows business travelers, students, and/or home users to utilize various components of a traditional desktop computer system without being limited by the time required to set-up and/or configure a desktop system, the space needed to operate a desktop system, and the inability to transport a desktop system. Any reference in this detailed description to front and back, right and left, top and bottom and upper and lower is intended for convenience of description, not to limit the present invention or its components to any one position or special orientation.

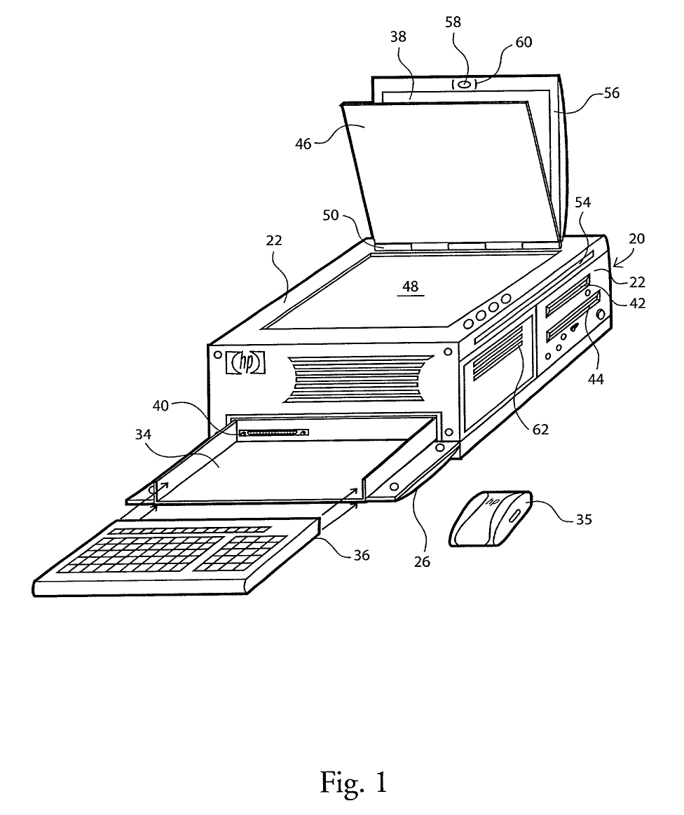

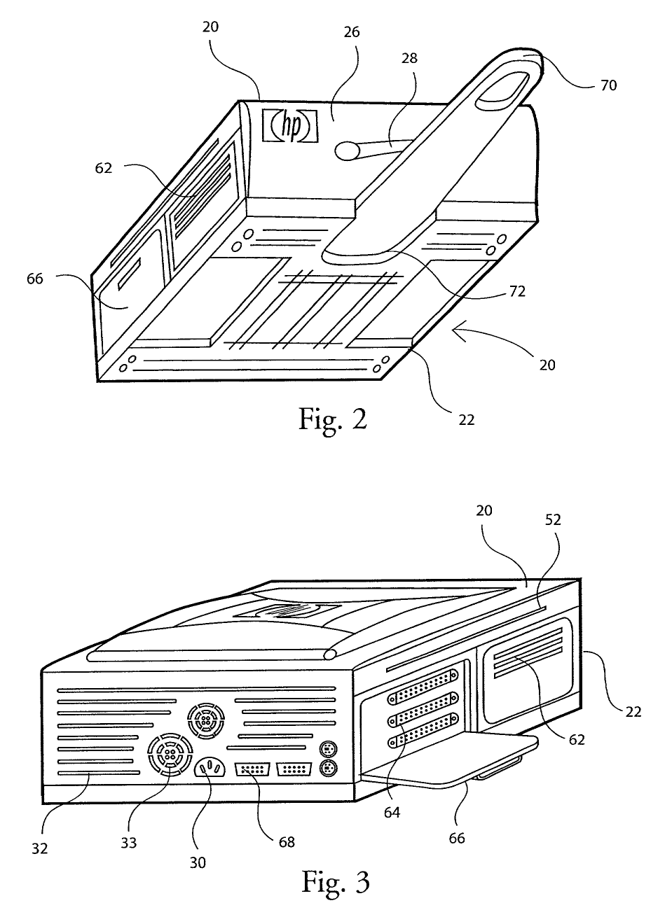

Referring now to the drawings and particularly to FIGS. 1 and 2, one embodiment of a portable personal computer system 20, in accordance with the principles of the present invention, is illustrated. The portable personal computer system 20 includes a system enclosure 22 preferably made of metal and/or plastic and formed in a rectangular shape having a top, a bottom, and four sides. The system enclosure 22 accommodates the features of the present invention and maintains a flat screen display 24 at a sufficient height to minimize strain on a user's neck while operating the portable personal computer system 20.

The system enclosure 22 includes a front cover 26 rotatably hinged at one end of the system enclosure 22. The front cover 26 may include a standard fastening mechanism (not shown) so that in its closed position, the front cover 26 remains closed until the fastening mechanism is released. A carrying handle 28 is disposed on the outside of the front cover 26 and capable of supporting the full weight of the portable personal computer system 20. The carrying handle 28 allows the user to carry the portable personal computer system 20 when the front cover 26 is in the closed position, and lift the system 20 into a carrying case (FIGS. 5 and 6) for transportation.

The system enclosure 22 preferably provides a rigid structural frame for housing the system's central processing unit (CPU) that contains multiple memory circuits, such as ROM and RAM, etc. The system enclosure 22 is connected to a power supply (not shown) via a power supply port 30 (FIG. 3). The system enclosure 22 further includes air vents 32 and may also include at least one fan 33 (FIG. 3) so as to allow air to circulate over the computer components inside the system enclosure 22 to sufficiently cool the personal computer system 20.

As shown in FIG. 1, the front cover 26 is in its open position. A tray 34 is disposed at the bottom of the system enclosure 22 behind the front cover 26 and is pulled out of the system enclosure 22. An infrared mouse 35 and an infrared keyboard 36 are stored in the tray 34 when they are not in use. In FIG. 1, the infrared mouse 35 and the infrared keyboard 36 are removed from the tray 34 for illustration purposes. An infrared sensor (not shown) for optical communication with the infrared mouse 35 and the infrared keyboard 36 is electrically connected to the computer components, such as the CPU, and mounted therein and proximate the front side of the portable personal computer system 20. The infrared mouse 35 and the infrared keyboard 36 transmit data to the infrared sensor in the manner known in the art. It is appreciated that the infrared sensor can be installed on a display 38 so that the infrared mouse 35 can be used like a laser pointer known in the art to minimize wrist movement by a user for operating the system, thereby reducing susceptibility to carpal tunnel syndrome. Further, the infrared keyboard 36, such as an infrared alpha-numeric keyboard, allows a user to efficiently interface with the portable personal computer system 20 without fixed connections. Input from a user is optically transmitted from the infrared keyboard 36 and/or mouse 35 to the infrared sensor, and is transformed to electronic signals to control a variety of computer processes.

In addition that the tray 26 is capable of fully housing the infrared keyboard 36, the tray 26 can slide outside of the system enclosure 22 when the front cover 26 is in an open position. The tray 26 may also contain a docking port 40 that allows the transfer of data between another computer, such as a laptop computer, and the portable personal computer system 20, and allows the portable personal computer system 20 to serve as a base computer if another computer is required for remote operations.

Also in FIG. 1, connected to the CPU through standard interfaces are the system's data storage devices, including a hard drive (not shown), a floppy disc and/or zip drive 42, and a CD and/or DVD drive 44. The hard drive is mounted inside the system enclosure 22 and at the base of the portable personal computer 20 in a compact manner. The floppy disc and/or zip drive 42 and the CD and/or DVD drive 44 are mounted in one or more standard storage bays within the system enclosure 22 in a manner that allows a user to place appropriate storage medium within the drives through a slot of the system enclosure 22 of the portable personal computer system 20.

A document scanning unit or module is also connected to the CPU and to the power supply through a standard electrical connection. The document scanning module captures images and text and allows the user to save the information to the memory components of the portable personal computer system 20. The document scanning module includes a scanning cover 46 that aids the scanning software in determining the size of the object being scanned, a transparent area 48 upon which a user places the document to be scanned, a scan head having components, such as mirrors, lenses, filters, and CCD array, etc., for producing an image of a document to be scanned, a stepper motor and belt combination providing mechanical means by which the scan head traverses the document to be scanned, a stabilizer bar insuring that the scan head traverses smoothly under the document to be scanned, and a lamp to illuminate the document to be scanned.

The scanning cover 46 is hinged to the system enclosure 22 via a standard hinge 50 so that in an open position, the scanning cover 46 can be positioned in a variety of angles including approximately perpendicular to the transparent area 48, and in a closed position, the scanning cover 46 can rest immediately over the transparent area 48. The standard hinge 50 is attached to the system enclosure 22 and, in the preferred embodiment, the hinge 50 is located along one side of the transparent area 48. The transparent area 48 is located in the upper portion of the system enclosure 22 and is visible when the scanning cover 46 is in its open position, allowing a user to place the document to be scanned directly on the transparent area 48 and below the closed scanning cover 46 with the particular side of the document to be scanned facing the transparent area 48.

The lamp is located within the system enclosure 22 in a position that enables to illuminate the entire document to be scanned. The scan head is positioned beneath the transparent area 48 and mounted for longitudinal movement across the document to be scanned. The stabilizer bar may be mounted within the system enclosure 22 by mounting brackets positioned near the right and left sides of the system enclosure 22 and in the same direction as the longitudinal movement of the scan head. A stepper motor (not shown) connected to the power supply through an electrical interface may be located within the system enclosure 22 and mounted for minimizing interference with the other components of the portable personal computer system 20. Upon input from a user directing the scanning operation to begin, the stepper motor drives the belt system that pulls the scan head along the upper side of the stabilizer bar and below the document to be scanned. The scan head may be allowed to move within a limited range of travel by the stepper motor, as determined by the size of the document to be scanned. The portable personal computer system 20 may be installed with the scanning software necessary to transform the images retrieved by the scan head into full color electronic pictures for eventual manipulation and transmission by the user.

A printing unit or module may be included within the system enclosure 22 and is electrically connected to the CPU and to the power supply. The printing unit allows the user to print the images and text captured by the scanning device or to print documents or faxes contained in the computer memory. The printing unit may utilize the stepper motor and belt system mounted within the system enclosure 22, may be synchronized therewith, or all units may be synchronized with a computer clock. A document feed-in slot 52 (FIG. 3) and a document exit slot 54 are preferably located horizontally along the sides of and towards the top of the system enclosure 22. A roller assembly, mounted within the system enclosure 22 and driven by the stepper motor and belt system, creates a document feed path directing a sheet of paper from the document feed-in slot 52 to the document exit slot 54. The printing module is mounted near the document feed-in slot 52 and aimed directly at the document feed path in such a way that a printing operation and a scanning operation share similar components but operate independently of one another. The printing module may be any compact commercially available printing module, such as an inkjet, dot-matrix, laser, etc.

Upon input from a user directing a printing operation to begin, the stepper motor drives the belt system that rotates the roller assembly and pulls a sheet of paper from the document feed-in slot 52 and along the document feed path. The printing unit prints the desired pattern, and the roller assembly carries the sheet of paper towards the document exit slot 54 and out of the system enclosure 22. Storage trays may be provided at the document feed-in slot 52 or at the document exit slot 54 to receive the printed documents. Printing software and drivers are pre-installed in the portable personal computer system 20 to allow immediate operation of the printing unit.

The display 38 is preferably a flat screen display. The flat screen display 38 is located within a display frame 56 and hinged to the system enclosure 22 via the standard hinge 50, so that in an open position, the flat screen display 38 can be positioned in a variety of angles including approximately perpendicular to the top of the system enclosure 22, and in a closed position, the flat screen display 38 can be positioned immediately over the closed scanner cover 46. The hinge 50 is configured and arranged to connect both the flat screen display 38 and the scanner cover 46, and allows each to rotate independently of one another. The flat screen display 38, a standard liquid crystal display of the type well known in the art or of any new technology in the future, visually displays the output generated by the software applications, such as a video card, and is connected electrically to the system's internal circuitry and to the system's power supply. The connection can be provided between a slot within the display frame 56 side of the hinge 50 and a corresponding slot within the system enclosure 22 side of the hinge 50. A cable connecting the flat screen display 38 to the internal circuitry can pass through the slots (not shown) to the system's internal circuitry regardless of the display frame's 56 positioning. In the preferred embodiment, the display frame 56 contains a standard fastening mechanism (not shown) that locks the flat screen display 38 and the scanning cover 46 in place while not in use. When needed, the user can unlock the fastening mechanism and rotate the flat screen display 38 and the scanning cover 46 in any desired position.

As part of a complete PC telephony system, one embodiment of the present invention includes a video cam 58, housed within a camera mounting bracket 60, for recording the surrounding view. A camera mounting bracket 60 is preferably located in the upper portion of and within the edge of the display frame 56. The mounting bracket 60 may include an opening suitably sized so that the video cam 58 can be force-fit into and housed within the opening. The video cam 58 may be of any number of standard mini video cams commercially available. The video cam 58 is electrically connected to the power supply and to the appropriate internal components of the portable personal computer system 20 by a cable that is mounted within the display frame 56 and, along with the flat screen display's 38 electrical connections, passes through the slots in the hinge 50 described previously. The video cam 58 may be slightly recessed from the surface of the display frame 56 to avoid contact between the video cam 58 and the system enclosure 22 when the display frame 56 is in the closed position. In the preferred embodiment, the video cam 58 and the camera mounting bracket 60 are arranged or positioned in such a way that avoids interference with the locking mechanism on the display frame 56.

Along with the video cam 58, the portable personal computer system's 20 complete PC telephony system may include a modem, at least one speaker, a microphone, a sound card, a video card, and PC telephony software, each fully enclosed within the system enclosure 22. The modem, sound card, and video card are mounted within and at the base of the portable personal computer system 20 in a compact manner similar to that of a portable laptop computer. The microphone and speaker(s) are mounted within and along a side of the system enclosure 22.

Slots 62 are located along the outside of the system enclosure 22 so that the sound-emitting side of the speaker and the sound-receiving side of the microphone are located directly behind the slots 62 to allow a user to clearly hear sound from the speaker(s) and to allow the telephony system to clearly receive and record sound from the user. These components are connected to the power supply and/or the motherboard through conventional interfaces. The PC telephony system allows communications with remote terminals and supports voice communication, voice messaging, faxes, video conferencing, and call, voice and e-mail routing.

Referring to FIG. 3, the power supply is connected to the CPU through standard interfaces and contained within a separate compartment located within and at the back side of the system enclosure 22 with standard mounting brackets. The power supply is designed in such a way that the power supply is contained within the system enclosure 22, and the electrical plug 30 located at the back of the system enclosure 22 can be the only visibly exposed component of the computer system 20. The electrical plug 30 is attached via a standard interface to an AC bus. The AC bus supplies power to each AC component of the portable personal computer system 20 through conventional interfaces. The AC bus also supplies power to a transformer which may reduce the AC voltage to an appropriate amount and convert the AC voltage to DC voltage. DC power is then supplied to each of the DC components in the portable personal computer system 20. The system's use of a simple power cord attached to a power source and to the plug 30 on the back side of the system enclosure 22 minimizes the clutter, confusion, and safety hazards of multiple power sources typically associated with a traditional computer system.

Also in FIG. 3, a series of ports 64 are disposed on the side of the system enclosure 22 allowing the portable personal computer system 20 to connect to a variety of external devices, including digital cameras, network cards, modems and information storage devices. The ports 64 are electrically connected directly to the system's motherboard. A port cover 66 is rotatably hinged at one end to the system enclosure 22 and contains a standard fastening mechanism so that in a closed position, the port cover 66 remains closed until the fastening mechanism is released. The port cover 66 protects the ports 64 in its closed position and allows full user access to the ports 64 in its open position. The backside of the system enclosure 22 also contains various I/O ports 68 for connecting the portable personal computer system 20 to devices, such as an external printer, monitor and keyboard. The I/O ports 68 can be connected directly to the system's motherboard.

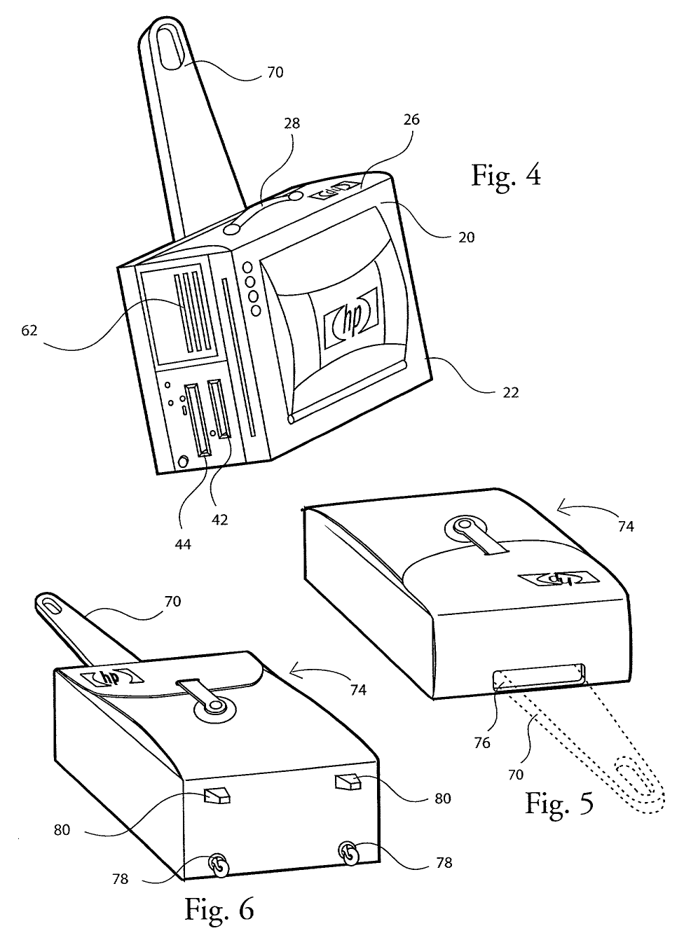

Referring to FIG. 4, the portable personal computer system 20 may include an extendable carrying handle 70, which maximizes a user's ability to transport the system 20. During operation of the portable personal computer system 20, the extendable carrying handle 70 can be fully contained within a handle storage compartment 72 (FIG. 2) in the bottom side of the system enclosure 22. The end of the extendable carrying handle 70 can be positioned flush with the front cover 26. When transporting the personal portable computer system 20, the extendable carrying handle 70 can be extended for ease in transportation. The extendable carrying handle 70 can extend a distance slightly less than the length of the portable personal computer system 20, and is held at that distance by a stopping mechanism that prevents the extendable carrying handle 70 from sliding out of the handle storage compartment 72.

Referring to FIGS. 5 and 6, the portable personal computer system 20 may include a case 74, such as a static free travel case, capable of housing, in its entirety, the portable personal computer system 20. The case 74 may be customized to fit the unique design of the portable personal computer system 20, and to allow the full extension of the extendable carrying handle 70. In the preferred embodiment, the case 74 includes an opening 76 positioned immediately over the extended carrying handle 70 so that a user can carry the portable personal computer system 20 by the extendable handle 70 when the system is completely enclosed by the case 70. On its bottom side, the case 70 may include one or more wheels 78 and one or more stops 80, allowing a user to comfortably carry the portable personal computer system 20 like a portable suitcase by dragging the system across and slightly above the ground. The wheels 78 and stops 80 are arranged in a particular design to maintain the portable personal computer system 20 in a stable vertical or upright standing position when not in use.

It will be appreciated that other computer modules or units can be included in the system 20. For example, a copying module or unit may be included in the system. It will also be appreciated that the modules or units described above may be configured in separate modules or units and arranged in a single enclosure according to their general functionalities in a system.

The described portable personal computer system 20 allows a user to efficiently access a variety of computer components while minimizing the desk space and set-up time needed for operation, and maximizing the user's ability to transport the system. The present invention is described in terms of an exemplary embodiment. However, one of ordinary skill in the art would recognize that the principles involved in the present invention can be easily implemented in various configuration designs, and that any such variation would be within the scope of the present invention.

1. A single unit system, comprising:
an enclosure having a power supply port disposed on outside of the enclosure;
a computer system configured and arranged in the enclosure; and
a handle and at least one wheel to transport the system by pulling the handle, wherein the handle is extendable from the enclosure and retractable into the enclosure.

2. The system of claim 1, wherein the computer system comprises a plurality of personal computer components including a CPU, memory, an input device, and an output device, a printing module, a scanning module, and a video cam.

3. A compact, self-contained, portable personal computer (PC) system, comprising:
a system enclosure having a plurality of computer components contained therein, the computer components including a CPU and a memory, and a power supply port disposed on one side of the system enclosure;
a scanning module, disposed in the system enclosure and electrically coupled to the computer components and the power supply port inside the system enclosure, to scan a document placed in the system enclosure;
a printing module, disposed in the system enclosure and electrically coupled to the computer components and the power supply port inside the system enclosure, to print a document controlled by the computer components;
a flat screen display module, disposed on top of the system enclosure and electrically coupled to the computer components and the power supply port inside the system enclosure, to display a personal computer application, the flat screen display being rotatably coupled to the system enclosure allowing the flat screen display to be viewable in an open position and to rest on the top of the system enclosure in a closed position; and
a first handle and at least one wheel to transport the system by pulling the first handle, wherein the first handle is extendable from the system enclosure and retractable into the system enclosure.

4. The system of claim 3, further comprising a tray disposed at bottom of the system enclosure and an input device stored inside the tray when the input device is not in use, wherein the tray includes a docking station port for communicating with a second computer system.

5. The system of claim 4, wherein the input device is an infrared keyboard operatively associated with the computer components in such a manner that an input from the keyboard is stored in the memory and displayable on the flat screen display.

6. The system of claim 4, wherein the input device is an infrared mouse operatively associated with the computer components in such a manner that an input from the infrared mouse is stored in the memory and displayable on the flat screen display.

7. The system of claim 3, wherein the system enclosure includes a document feed-in slot and a document exit slot disposed on opposite sides of the system enclosure, respectively, such that the scanning module scans the document fed into the document feed-in slot and outputs the document at the document exit slot.

8. The system of claim 3, further comprising a video cam, disposed on the flat screen display, to record a view around the system.

9. The system of claim 3, further comprising a case to house the system, wherein the case includes a first opening for accessing the first handle.

10. The system of claim 9, further comprising a second handle for carrying/lifting the system.
